(19) United States
(12) Patent Application Publication
(10) Pub. No.: US 2007/0069492 A1
(43) Pub. Date: Mar. 29, 2007

(54) Skateboard

(76) Inventor: Henkel Lin, Taichung Hsien (TW)

Correspondence Address: COOPER & DUNHAM, LLP, 1185 AVENUE OF THE AMERICAS, NEW YORK, NY, 10036, US

(21) Appl. No.: 11/234,641

(22) Filed: Sep. 23, 2005

(51) Int. Cl. B62M 1/00

(52) U.S. Cl. 280/87.042

(57) ABSTRACT

A skateboard includes a light timber board connected with two hard timber boards at two ends. Two carbon fiber composite boards are adhered to two sides of the light timber board, and two timber veneers are adhered respectively onto the two carbon fiber composite boards. The application of the light timber board reduces the weight of the skateboard, and the carbon fiber composite boards enhance the structural strength and the resilience.

### BACKGROUND OF THE INVENTION

1. Field of the Invention

The present invention relates to a skateboard, and particularly relates to a light skateboard made of light timber board and carbon fiber composite board.

2. Description of the Related Art

With reference to FIGS. 4 and 5, a conventional wooden skateboard (50) is made of seven layers of timber board adhered together to form a laminate. The two ends of the skateboard (50) are curved upward. The seven layers of timber board are composed of five longitudinal-grained boards (51) and two cross-grained boards (52). The two cross-grained boards (52) sandwich one longitudinal-grained board (51). The remaining four longitudinal-grained boards (51) are mounted over the cross-grained boards (52); two longitudinal-grained boards (51) cover each cross-grained board (52), respectively. An adhesive composition, such as a resin, is spread between the seven layers of timber board, which are then laminated, or sandwiched, together tightly to form a skateboard.

However, as the skateboard is made of multiple timber boards, there are some disadvantages:

1. It is comparatively heavy: Each board has some weight, and as the skateboard is made of seven boards, it can be quite heavy.

2. It is easily deformed and its resilience is easily lost: The timber board skateboard can easily lose its resilience if it is bent several times, and if the board is exposed to a humid environment, it will get wet and become deformed.

3. It is comparatively thick: Seven layers timber of board are combined together to provide the necessary strength, so it will be about 11 mm thick.

Therefore, the invention provides a skateboard to mitigate or obviate the aforementioned problems.

### SUMMARY OF THE INVENTION

The main objective of the present invention is to provide a skateboard that has an enhanced structural strength and resilience and comprises a light timber board, two carbon fiber composition boards adhered to two sides of the light timber board, and two timber veneers adhered onto the two carbon fiber composition boards.

Furthermore, two hard timber boards having the same thickness as the light timber board are connected respectively at the two ends of the light timber board.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a skateboard (with wheels mounted) in accordance with the invention;

FIG. 2 is an exploded view of the skateboard in accordance with the invention;

FIG. 3 is a sectional view of the skateboard (with wheels mounted) in accordance with the invention;

FIG. 4 is a perspective view of a conventional skateboard; and

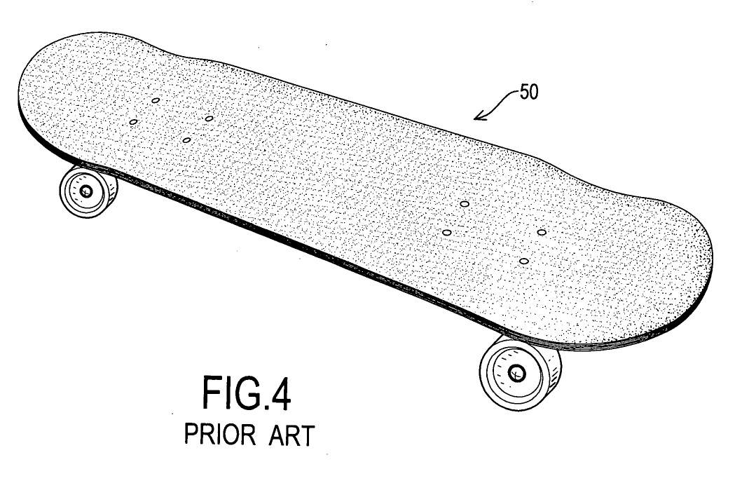

FIG. 5 is an exploded view of the laminated layers of the conventional skateboard.

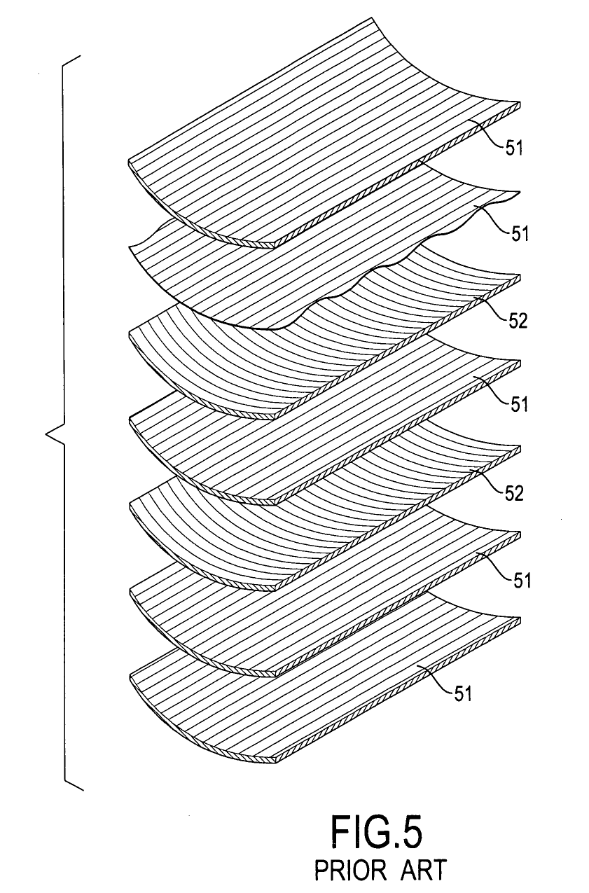

### DETAILED DESCRIPTION OF THE PREFERRED EMBODIMENT

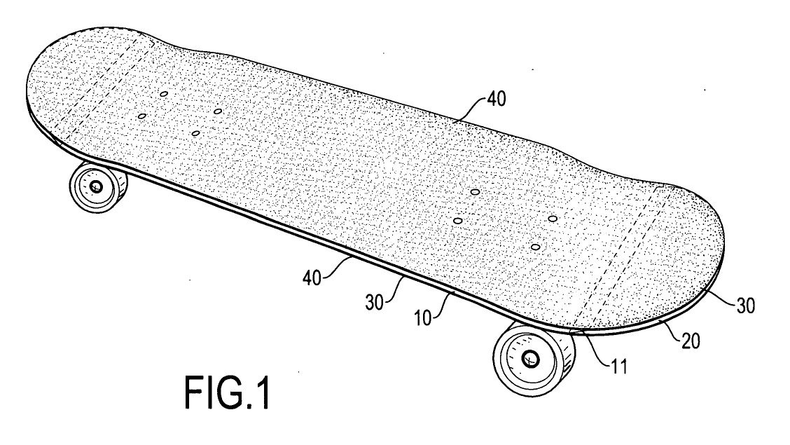

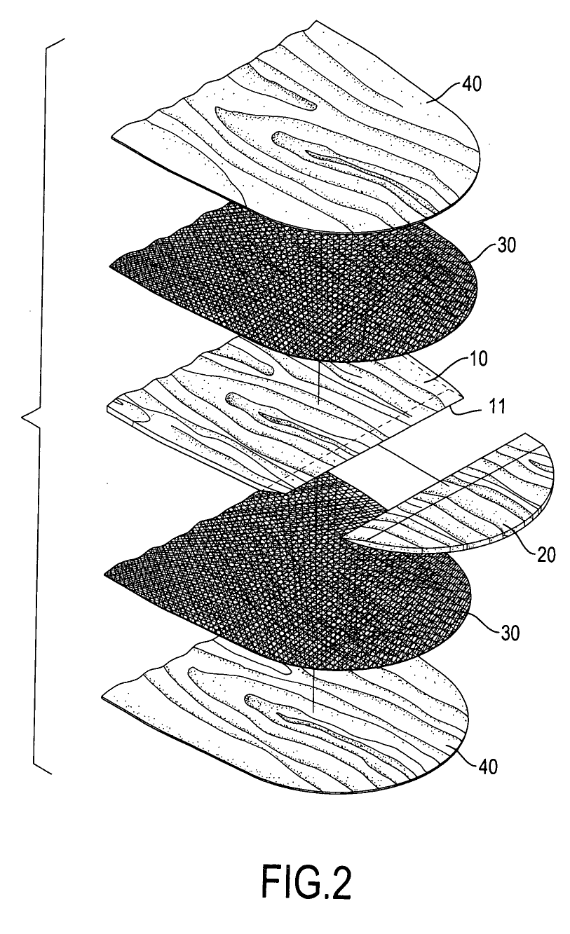

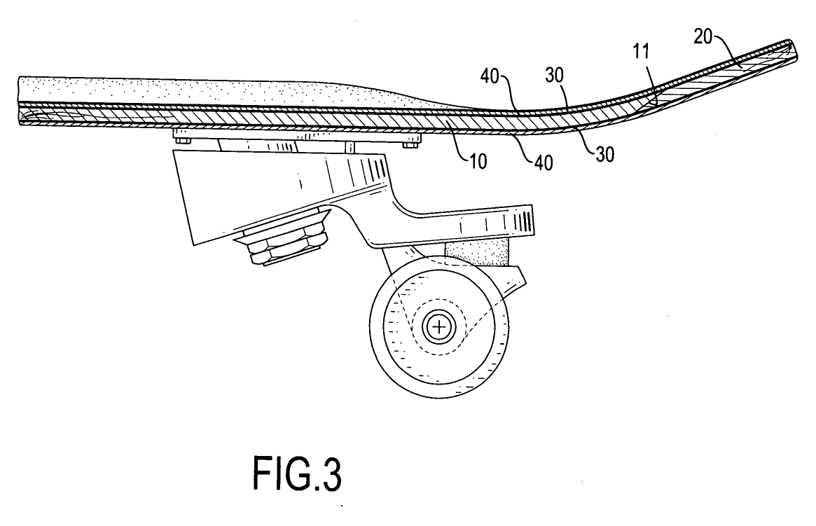

With reference to FIG. 1-3, a skateboard comprises:

A light timber board (10) made of light lumber, such as balsa wood. The light timber board (10) has two symmetrical longitudinal edges and two beveled ends (11).

Two hard timber boards (20) of semi-circular shape having the same thickness as the light timber board (10), each hard timber board (20) has a diametrical beveled edge and a round edge. The two hard timber boards (20) are connected respectively at the diametrical edges to the beveled ends (11) of the light timber board (10), thus forming a shape of a skateboard.

Two carbon fiber composite boards (30) having the shape of the skateboard are adhered respectively onto each side of the light timber board (10).

Two timber veneers (40) also having the shape of the skateboard are adhered respectively onto the carbon fiber composite boards (30).

The skateboard in accordance with the invention has the following advantages.

1. The skateboard has five layers, which is less than the conventional skateboard. The light timber board (10) is almost the same thickness as the conventional skateboard, but is much lighter, which effectively lightens the skateboard.

2. The application of the carbon fiber composition board (30) enhances the structural strength and resilience of the skateboard.

3. The light timber board (10) is soft, but two hard timber board pieces can be added to the nose and tail of the skateboard. The hard timber board (20) can endure frequent scraping and enhances the durability of the skateboard.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A skateboard comprising:
a light timber board having two sides;
two carbon fiber composite boards adhered to the two sides of the light timber board; and
two timber veneers adhered respectively onto the two carbon fiber composite board.

2. The skateboard as claimed in claim 1, wherein two hard timber boards having a same thickness as the light timber board are connected with the light timber board, and the two carbon composite boards are adhered respectively onto the light timber board and the hard timber boards.
